(19) United States
(12) Patent Application Publication
(10) Pub. No.: US 2026/0079611 A1
(43) Pub. Date: Mar. 19, 2026

(54) Format Lock

(71) Applicant: DISH Network L.L.C., Englewood, CO (US)

(72) Inventors: Ryan Plummer, Shawsville, VA (US); April Baik, Lone Tree, CO (US); Osabhie Ebenezer Ferguson, Blacksburg, VA (US)

(73) Assignee: DISH Network L.L.C., Englewood, CO (US)

(21) Appl. No.: 18/889,717

(22) Filed: Sep. 19, 2024

(51) Int. Cl. G06F 3/0484; G06F 3/0482; G06F 40/109; G06F 40/117

(52) U.S. Cl. CPC G06F 3/0484; G06F 3/0482; G06F 40/109; G06F 40/117

(57) ABSTRACT

Devices, systems, computer readable mediums, and processes for facilitated locked format editing of digital content are described. A user device include a user device data store (UDDS) that non-transitorily stores first computer instructions which, when executed, by a user device processor instantiate a format settings engine (FSE). The FSE configures the user device to perform format locking operations (FLO) that include locking a format style setting option for editing a digital content by a user. A user interface presents multiple format style setting options that the user may select and user edits to the digital content are distinguishable from other edits to the digital content by a second or another user. The format style setting options may include a font, a style, a size option, and a color option. The FLO may also include determining whether one or more of the options have been reserved for another user's use.

### TECHNICAL FIELD

The technology described herein generally relates to devices, systems, and processes by which a given user may lock formatting of digital content.

### BACKGROUND

A given user commonly may collaborate with other users on the preparation, editing, commenting and the like (herein “editing”) on various forms of content. Non-limiting examples of such various forms of content include textual documents, spreadsheets, graphical content, emails, text messages, photographs, videos, multi-media content, audio content, and the like (herein, individually and collectively “digital content”). When editing digital content, a user often desires for their edits to the digital content (which may arise by means of addition, deletion, revision, adaptation, or otherwise) to be discernible from other user's edits to the digital content. For a non-limiting example, a user providing comments on a received email may identify their comments from others, previously provided, edits to the email by using a particular color, font, style, or the like. For example, a user may distinguish their comments by providing them in red, bold text, or the like (such being used herein as a “format style”—which is further defined herein).

When the user desires to enter their comments, using a given format style, across multiple, divisible portions of the digital content (e.g., with regards to a first paragraph and a 4^{th} paragraph in an email), the user commonly has to reselect the one or more formatting settings associated with a given format style for each of the divisible portions of the digital content. Such practices are common today and often result in inefficiencies, as the user is commonly required to repeatedly select (and reselect) one or more formatting settings in order to distinguishably provide edits to a given digital content at various, non-contiguous portions therein.

Further, such practices may result in inconsistent treatments and interpretations by others of the various portions of the digital content, as edited by one or more users. For example, a user might initially use a red font setting during a first editing of a given document and another user then use the same (or substantially similar) red font setting during a second editing of the given document. Another user would thus have a difficult time distinguishing between edits previously presented during the first editing by the first user versus those presented during the second editing by the second user.

Similarly, two or more users may seek to routinely utilize the same, or substantially similar, font settings when editing multiple instances of digital content. For a non-limiting example, a first user might use red font (an example of a format setting) while a second user also uses the red font, when each user are cooperatively and respectively editing one or more instance of digital content. Since the format settings are identical, at least with respect to the color used to prevent their respective edits, discerning between the edits as to the source thereof, e.g., by a third user, is typically difficult without having each of the first user and the second user specifically identify, select (and often reselect) the particular and uniquely associable (with such given user) format setting to be used for a given digital content and, often, multiple instance of digital content.

Accordingly, devices, systems, methods and computer executable instructions are needed which facilitate the setting/locking of respective format settings by two or more users editing one or more instances of digital content.

### SUMMARY

Various implementations are described of devices, systems, and processes by which a first user may lock, and utilize, one or more first format settings by which the first user may edit one or more forms of digital content. The format lock may inhibit one or more second users from editing one or more forms of digital content with respect to which both the first user and the one or more second users desire to collaborate, comment, edit or otherwise engage with the various users.

In accordance with at least one implementation of the present disclosure, a system of one or more computers can be configured to perform particular operations or actions by virtue of having software, firmware, hardware, or a combination thereof installed on the system that, in operation, cause(s) the system to perform the actions. One or more computer programs can be configured to perform particular operations or actions by virtue of including instructions that, when executed by a data processing apparatus, cause the apparatus to perform the actions.

For at least one implementation of the present disclosure, a user device may include a user device data store (UDDS), that non-transitorily stores first computer instructions which, when executed, instantiate a format settings engine (FSE), and a user device processor (UDP) coupled to the UDDS. The UDP, when executing the first computer instructions, instantiates the FSE which configures the user device to perform format locking operations (FLO) that include locking at least one format style setting option for editing of a given digital content by a first user of the user device. For at least one implementation, the user device may further include a user interface, coupled to the UDP, that presents multiple format style setting options to the first user. The locking of the at least one format style setting option may include receiving a first selection, by the first user, of at least one of the multiple format style setting options. Upon the first selection of the at least one of the multiple format style setting options, edits made by the first user to the given digital content may be distinguishable from other edits made to the given digital content by a second user or another user.

For at least one implementation of the user device, the user device may further include a communications interface coupling the user device with a second user device utilized by the second user. The FLO may further include communicating, substantially contemporaneously with an entry of the edits by the first user and in accordance with the at least one of the multiple format style setting options selected by the first user, the edits to the given digital content to the second user device. The multiple format style setting options may include at least one of a font setting option, a style setting option, a size setting option, and a color setting option. The multiple format style setting options may be provided by an application program that facilitates editing of the given digital content. The application program may be at least one of a document editor, a spreadsheet editor, a photo editor, and a video editor.

For at least one implementation of the user device, the FLO may further include determining whether at least one of the multiple format style setting options selected by the first user in the first selection are reserved for use by another user. The FLO may further include informing the first user when at least one of the multiple format style setting options selected in the first selection are reserved and receiving a second selection of another of at least one of multiple format style setting options that are not reserved for use by another user.

For at least one implementation of the user device, the UDDS may non-transitorily store second computer instructions which, when executed by the UDP, instantiate an application settings module (ASM). The UDP, when executing the second computer instructions, may instantiate the ASM which configures the user device to perform application settings operations (ASO) that may include presenting a format locking mode on the user device. The format locking mode may include a menu bar extension mode and the menu bar extension mode may include a format lock plug-in which facilitates the locking of the first selection of the at least one format style setting option during editing of the given digital content by the first user of the user device. For at least one implementation, the format lock plug-in, when selected by the first user, may present format lock control options including at least one of a lock option, a save option, a recall option, and a clear option. The lock option, when selected by the first user, locks the first selection of the at least one of the multiple format style setting option.

For at least one implementation of the user device, the UDDS may non-transitorily store third computer instructions which, when executed by the UDP, instantiate a format preferences module (FPM). The UDP, when executing the third computer instructions, may instantiate the FPM which configures the user device to perform format preferencing operations (FPO) that may include determining whether the first user has previously stored the first selection in the UDDS. When the first selection is previously stored, the FPO may further include retrieving the first selection from the UDDS and providing the first selection to the FSE. The first selection of the at least one format style setting may be utilized by the application program during editing of the digital content by the first user.

For at least one implementation of the present disclosure, a system that facilitates locking of format settings for two or more users editing a given digital content may include a first user device (1UD). The 1UD may include a first user device data store (1UDDS) that non-transitorily stores first user device first computer instructions (1UD1CI) which, when executed, instantiate a first format settings engine (1FSE). The 1UD may also include a first user device processor (1UDP) coupled to the 1UDDS which, when executing the 1UD1CI, instantiates the 1FSE which configures the 1UD to perform first format locking operations (1FLO) . The 1FLO may include first locking a first format style setting option for editing of a given digital content by a first user of the 1UD.

The system may further include at least one second user device (2UD), coupled to the 1UD, that includes a second user device data store (2UDDS) that non-transitorily stores second user device first computer instructions (2UD1CI) which, when executed, instantiate a second format settings engine (2FSE) and a second user device processor (2UDP) coupled to the 2UDDS. The 2UDP, when executing the 2UD1CI, may instantiate the 2FSE which configures the 2UD to perform second format locking operations (2FLO) . The 2FLO may include second locking a second format style setting option for editing of the given digital content by a second user of the 2UD.

The system may further include a format lock server, coupled to the 1UD and the 2UD, that includes a server data store (SDS) that non-transitorily stores server first computer instructions (S1CI) which, when executed, instantiate a server format settings engine (SFSE) and a server processor (SP) coupled to the SDS. The SP, when executing the S1CI, may instantiate the SFSE which configures the server to perform server format locking operations (SFLO) that may include receiving, from the 1UD, the first format style setting option locked by the 1FSE and receiving, from the 2UD, the second format style setting option locked by the 2FSE.

For at least one implementation of the system, the first format style setting option locked by the 1FSE may be different than the second format style setting option locked by the 2FSE. For at least one implementation, the SFLO may further include communicating, to the 2UD and a third user device, edits by the first user to the given digital content in accordance with the first format style setting option and communicating, to the 1UD and the third user device, edits by the second user to the given digital content in accordance with the second format style setting option.

For at least one implementation of the system, the 1UDDS may non-transitorily store 1UD second computer instructions (1UD2CI) which, when executed, instantiate a first application settings module (1ASM). The 1UDP, when executing the 1UD2CI, may instantiate the 1ASM which configures the 1UD to perform first application settings operations (1ASO) that may include first presenting a first format locking mode on the 1UD. The 2UDDS may non-transitorily store 2UD second computer instructions (2UD2CI) which, when executed, instantiate a second application settings module (2ASM). The 2UDP, when executing the 2UD2CI, may instantiate the 2ASM which configures the 2UD to perform second application settings operations (2ASO) that may include second presenting a second format locking mode on the 2UD.

For at least one implementation of the system, the first format locking mode and the second format locking mode may include at least one of a menu bar extension mode, a collaboration bar mode, and a side panel extension mode. For at least one implementation, the menu bar extension mode may include a format lock plug-in that facilitates the locking of selections of at least one of the first format style setting option and the second format style setting option during a respective editing of the given digital content by the first user or the second user.

For at least one implementation of the system, the 1UDDS may non-transitorily store 1UD third computer instructions (1UD3CI) which, when executed, instantiate a first format preferences module (1FPM). The 1UDP, when executing the 1UD3CI, may instantiate the 1FPM which configures the 1UD to perform first format preferencing operations (1FPO) that may include first determining whether the first user has previously stored the first selection in the 1UDDS and, when previously stored, retrieving the first selection from the 1UDDS and providing the first selection to the 1FSE. The first selection of the at least one format style setting may be utilized by an application program during editing of the digital content by the first user.

For at least one implementation of the present disclosure, a computer readable medium may non-transitorily store computer instructions which, when executed by a processor, instantiate a format settings engine which configures a user device to perform format locking operations that may include locking at least one format style setting option for editing of a given digital content by a first user of the user device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of various implementations of the present disclosure is provided in the following written description and illustrated in the accompanying drawings.

### BRIEF DESCRIPTION OF THE DRAWINGS

The features, aspects, advantages, functions, modules, and components of the devices, systems, and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference label irrespective of any additional alphabetic designators or second reference labels, if any.

FIG. 1 is a schematic illustration of an implementation of a format locking system (FLS) and in accordance with at least one implementation of the present disclosure.

FIG. 2 is a flow chart illustrating a process by which a file format settings engine (FFSE) performs one or more file format locking operations (FLO) and in accordance with at least one implementation of the FLS described in the present disclosure.

FIGS. 3A-3D are an illustrative example of a user interface providing a menu bar extension mode of format locking and in accordance with at least one implementation of the FLS described in the present disclosure.

### DETAILED DESCRIPTION

Various implementations of the present disclosure describe devices, systems, and processes by which a given user may lock use of one or more format settings, on a permanent, temporary, time-based, or other basis, during editing of one or more instances and/or forms of digital content.

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals.” An AIO signal may include an audible signal or a visible signal and may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI includes hardware and computer instructions (herein, “AIO technologies”) which supports the input and output of other signals with a user.

“Application” (which are also commonly referred to as a “computer program”) herein refers to a set of computer instructions that configure one or more processors to perform one or more tasks that are other than tasks commonly associated with the operation of the processor itself (e.g., a “system software,” an example being an operating system software), or the providing of one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like. For at least one implementation, an application may be configured as, include, and/or utilize a “plug-in” (as described below).

“AI/ML” (Artificial Intelligence/Machine Learning) herein refers to the use of one or more supervised learning, unsupervised learning, and/or refinement learning processes (as executed by one or more processors which may include processors associated with one or more neural networks) to perform one or more of the operations of the various computer engines described herein.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize, and capture comments spoken by a user and intended as audible signals for sharing with other users, inputting commands, or otherwise.

“Bus” herein refers to any known and/or later arising technologies which facilitate the transfer of data within and/or between components of a device. Non-limiting examples include Universal Serial Bus (USB), PCI-Express, Compute Express Link (CXL), IEEE-488bus, High Performance Parallel Interface (HIPPI), and the like.

“Cloud” herein refers to cloud computing, cloud storage, cloud communications, and/or other technology resources which a given user does not actively manage or provide. A usage of a Cloud resource may be private (limited to various users and/or uses), public (available for multiple users and/or uses), hybrid, dedicated, non-dedicated, or otherwise. It is to be appreciated that implementations of the present disclosure may use Cloud resources to provide for processing, storage and other functions related to facilitating AET functions. An implementation may utilize Cloud resources using any known or later arising data delivery, processing, storage, virtualization, or otherwise technologies, standards, protocols (e.g., the Simple Object Access Protocol (SOAP), the Hyper Text Transfer Protocol (HTTP), Representational State Transfer protocol (REST), or the like. Non-limiting examples of such technologies include Software as a Service (SaaS), Platform as a Service (Paas), Infrastructure as a Service (Iaas), and the like. Cloud resources may be provided by one or more entities, such as AMAZON WEB SERVICES provided by Amazom. com Inc., AZURE provided by Microsoft Corp., and others.

“Component” herein refers to a Module of a Device, as further defined herein.

“Computer Data” herein refers to Data, as further defined herein.

“Computer engine” (or “engine”) herein refers to a combination of a processor and computer instruction(s). A computer engine executes computer instructions to perform one or more logical operations (herein, a “logic”) which facilitate various actual (non-logical) and tangible features and function provided by a system, a device, and/or combinations thereof.

“Computer instruction” herein refers to an Instruction, as further defined herein.

“Communications Interface” herein refers to one or more separately provided components and/or integrated with other components of a Device that is configured to facilitate communication of data with one or more other devices using a Coupling.

Non-limiting examples of communications interfaces including networking cards, Wi-Fi™ modules, Ethernet ports, Bluetooth radio modules, wireless radio modules, and the like. Any known or later arising components, technologies, protocols, communications mediums, or the like may be used as a communications interface in a given device in an ETS.

“Content” and “Digital Content” (which are used interchangeably herein) refer to data that that may be presented, using a suitable presentation device, to a user in a humanly perceptible format. When presented to a human, the data becomes “information.” Non-limiting examples of content include text documents, spreadsheets, photos, videos, text messages, chat data, images, graphics, television programs, streaming video, music, or otherwise. Content may include, for example and not by limitation, one or more sounds, images, video, graphics, characters or otherwise. The content may originate from any source, including live and/or recorded, augmented reality, virtual reality, computer generated, or otherwise. The content may be presented to a given user using any user device and any user interface. Content may be stored, processed, communicated, or otherwise utilized. Content may identify artists, events, venues or the like.

“Coupling” herein refers to the establishment of a communications link between two or more elements of a given system. A coupling may utilize any known and/or later arising communications and/or networking technologies, standards, protocols or otherwise.

Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), Voice Over IP (VOIP), Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Data” herein refers to any representation of facts, information or concepts in a form suitable for processing, storage, communication, or the like by one or more electronic device processors, data stores, routers, gateways, or other data processing and/or communications devices and systems. Data, while and/or upon being processed, may cause or result in an electronic device or other device to perform at least one function, task, operation, provide a result, or otherwise. Data may be communicated, processed, stored and/or otherwise exist in a transient, non-transient, transitory and/or non-transitory form, as determined by any given state of such data, at any given time. For a non-limiting example, a given data packet may be non-transitory while stored in a storage device, but transitory during communication of the given data packet from a first device or system to a second (or more) device or system. As used herein and when received and stored in one or more of a cache, a memory, a data storage device, or otherwise, the given data packet has a non-transitory state. For example, and not by limitation, data may take any form and may be stored, in a data store, in a data file or other structure, hierarchy, or the like.

“Data store” herein refers to any device or combinations of devices, and/or components of a device, combinations of components of one or more devices, or the like configured to store data and computer instructions on a temporary, permanent, non-transitory, non-transient, and/or other basis. A data store is also referred to herein as a “computer readable medium” and/or a “non-transitory computer readable medium.” A data store may store data and computer instructions in any form, such as electrically, magnetically, physically, optically, or otherwise. A data store may include a cache on a processor, memory devices, or other physical component with non-limiting examples including random access memory (RAM) and read only memory (ROM) devices, and the like. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising data storage device technologies may be utilized for a given data store. Available storage provided by a given one or more data stores may be partitioned or otherwise designated by a storage controller as providing for permanent storage and temporary storage. Non-transitory data, computer instructions, or other the like may be suitably stored in a data store permanently or temporarily. As used herein, permanent storage is distinguished from temporary storage, with the latter providing a location for temporarily storing data, computer instructions, variables, or the like for a then arising or soon to arise data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transitory and/or transient storage of data. Permanent storage and/or temporary storage may be used to store data and computer instructions which, while communicated may be transitory or transient, but while stored, is defined herein to be a form of non-transitory and non-transient data and/or computer instruction.

“Device” herein refers to any known or later arising electrical device configured to, singularly and/or in combination, communicate, manipulate, output (e.g., for presentation as information to a human), process, store, or otherwise utilize data. Non-limiting examples of devices include personal computers (e.g., a THINKPAD™ computer manufactured by Lenovo Corporation), table computing devices (e.g., an IPAD™ manufactured by Apple Inc. of Cupertino, California, USA), a smart phone (e.g., a GALAXY S24™ manufactured by Samsung Corporation), and other devices configured to enable a given user to provide edits to one or more instances of digital content.

“Digital content editor” herein refers to any computer instructions which facilitate editing of a given data (which is also referred to herein as “digital content”). A digital content editor may be instantiated as an “application” (as defined herein), an “engine” (as defined herein), a “module” (as defined herein), a “plug-in” (as defined herein), and/or otherwise. Non-limiting examples of digital content editors include: Microsoft's WORD™, EXCEL™, VISIO™, POWERPOINT™, OUTLOOK™, PUBLISHER™, PROJECT™, and the like; and Google's DOCS™, SHEETS™, SLIDES™, GMAIL™, and the like. Other applications provided by, and without limitation, Apple, Adobe, and others which facilitate editing by two or more users of digital content are included in the definition of “digital content editor.” It is to be appreciated that for at least one implementation, a digital content editor may include the use of AI/ML (as defined herein) such that an editing of a given digital content may include use of one or more format locks which identify, using one or more format settings, a source of a given edit to the given digital content as being an AI/ML device, system, process, or the like. For example, an AI/ML format lock may include incorporation of an immutable and/or permanent watermark, or the like, which identifies the source, in whole or in part, of a given digital content, as being an AI/ML device, system, and/or process. It is to be appreciated that when AI/ML editing occurs, such AI/ML editing may include use of a format lock that is unique to a given digital content, common to two or more (but not all) instances of digital content, and/or common to all instances of digital content edited by a given AI/ML device, system, process, or the like.

“Instruction” (which is also referred to herein as a “computer instruction”) herein refers to a non-transitory processor executable instruction, associated data structures, sequence of operations, program modules, or the like. An instruction may be stored in a data store or otherwise for use and execution by a processor in a device, server, or the like. An instruction is described by an instruction set. It is commonly appreciated that instruction sets are often processor specific and accordingly an instruction may be executed by a processor in a language format (e.g., a machine language format) that is translated from a higher level programming language (e.g., C++). An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient, non-transient, transitory and/or non-transitory basis, as may arise for any given data, content and/or instruction. While the computer code provided by one or more instructions is being utilized to instruct and/or configure a device, server, or the like to perform one or more than arising or later occurring operations, such use is herein deemed to occur on a non-transient and non-transitory basis.

“Module” herein refers to and, when claimed, recites definite structure for a device that is configured to provide at least one feature and/or output signal and/or perform at least one function including one or more of the features, output signals and functions described herein. A module may provide the one or more functions using computer engines, processors, computer instructions, applications, modules, and the like. When a feature, output signal and/or function is provided, in whole or in part, using a processor, one more software components may be used, and a given module may include a processor configured to execute computer instructions. A person having ordinary skill in the art (a “PHOSITA”) will appreciate that the specific hardware and/or computer instructions used for a given implementation will depend upon the functions to be accomplished by a given module. Likewise, a PHOSITA will appreciate that such computer instructions may be provided in firmware, as embedded software, provided in a remote and/or local data store, accessed from other sources on an as-needed basis, or otherwise. Any known or later arising technologies may be used to provide a given module and the features and functions supported therein.

“Plug-in” (which are also commonly referred to as an “add-on” by the MOZILLA foundation, as an “add-in” by MICROSOFT, as an “extension” by GOOGLE, or the like), herein refers to one or more computer instructions that are provided as a software component that adds one or more specific features to an existing application, such as an existing digital content editor. For at least one implementation of the present disclosure, a plug-in may utilize services provided by a host application. The plug-in typically registers with the host application and a protocol is utilized by which data may be exchanged by and between the host application and the plug-in. For at least one implementation, a plug-in may be implemented as a shared library which gets dynamically loaded when a corresponding host application is instantiated.

“Power Supply/Power” herein refers to any known or later arising technologies which facilitate the providing to and/or use by a device of electrical power. Non-limiting examples of such technologies include batteries, power converters, inductive charging components, line-power components, solar power components, and otherwise.

“Processor” herein refers to one or more known and/or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, multi-threaded, and otherwise.

“Security Component/Security /dule/ Security” herein refers to any known or later arising components, processors, computer instructions, modules, and/or combinations thereof configured to secure data as communicated, processed, stored, output for presentation to a user, or otherwise manipulated. Non-limiting examples of security components include those which implement encryption/decryption standards, such as an Advanced Encryption Standard (AET), and transport security standards, such as Transport Layer Security (TLS) or Secure Sockets Layer (SSL).

“Server” herein refers to one or more devices that include computer hardware and/or computer instructions that provide functionality to one or more other programs or devices (collectively, “clients”). Non-limiting examples of servers include content servers, database servers, file servers, application servers, web servers, communications servers, virtual servers, computing servers, and the like. Servers may be combined into clusters (e.g., a server farm), logically or geographically grouped, combined into neural networks, or otherwise configured and/or utilized. Any known or later arising technologies may be used for a server. A server may instantiate one or more computer engines as one or more threads operating on a computing system having a multiple threaded operating system, such as the WINDOWS, LINUX, APPLE OS, ANDROID, and other operating systems, as an application program on a given device, as a web service, as a combination of the foregoing, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configurable to communicate data using a network, directly or indirectly, to another device, to another server, or otherwise.

“Substantially simultaneous(ly)” herein refers to an absence of a greater than expected and humanly perceptible delay between a first event or condition and a second event or condition. Substantial simultaneity may vary in a range of quickest to slowest expected delay, to a moderate delay, or to a longer delay.

“User” herein refers to a single person and/or a group of users whose edits to a given digital content are viewed as arising from a single origin or source.

“User Device (UD)” herein refers to a device configured for use by a user to communicate, generate, compute, present, process, store, or otherwise manipulate data and/or information. Non-limiting examples of user devices include smartphones, laptop computers, tablet computing devices, desktop computers, smart televisions, smart glasses, virtual reality glasses, augmented reality glasses, earbuds/headphones and other audible output devices, and other devices.

“User Interface” herein refers to one more components, provided with or coupled to a device configured to receive information from and/or present information to a user and convert information to data and vice versa. A user interface may include one more Additional I/O interfaces, Audio I/O interfaces, and Visual I/O interfaces.

“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, augmented reality images, virtual reality images, and otherwise. A visual I/O interface includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

### Format Locking System 100

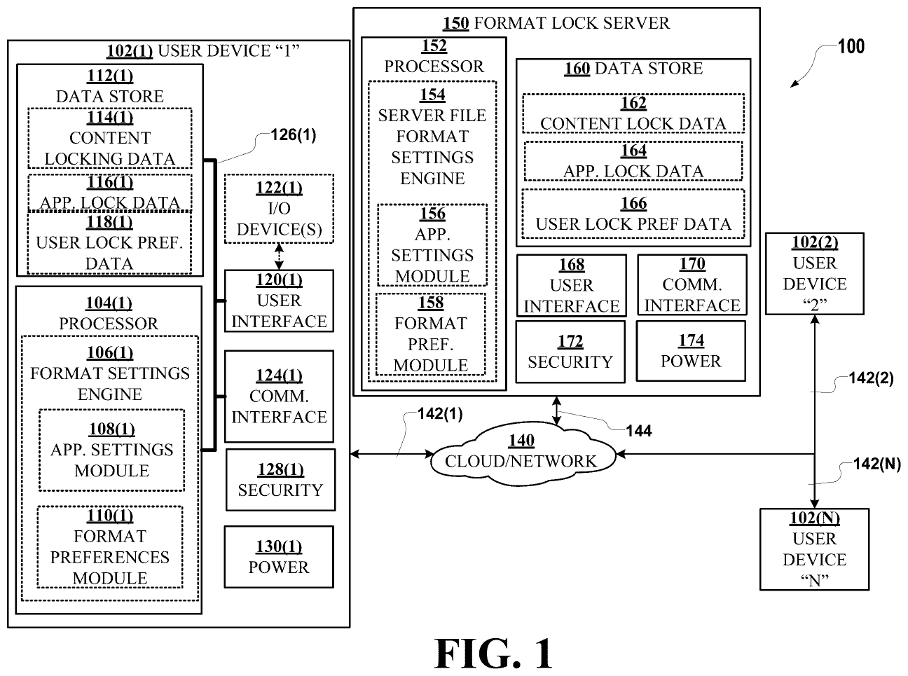

As shown in FIG. 1 and for at least one implementation of the present disclosure, a format locking system (FLS) 100, may include one or more combinations and/or permutations of: at least one user device (UD) 102 which for at least one implementation may include a first user device (1UD) 102(1), a second user device (2UD) 102(2), and an Nth user device (NUD) 102(N), where “N” is an integer, a format lock server (“server”) 150; and a Cloud/network 140, which for at least one implementation may be implemented using a Cloud based network.

The FLS 100 also includes various couplings including various user device (UD) to Cloud couplings (UDC) 142, such as a first UDC coupling 142(1) (coupling the 1UD 102(1) with Cloud 140), a second UDC 142(2) (coupling the 2UD 102(2) with the Cloud 140), and an Nth UDC 142(N) (coupling the Nth UD 102(N) with the Cloud 140). Other couplings may include a server to cloud coupling 144.

### User Device (UD) 102

As further shown in FIG. 1 and purposes of this description, the 1UD 102(1), 2UD 102(2) and NUD 102(N) are commonly described with elements thereof being shown in FIG. 1 for purposes of conciseness with respect to the 1UD 102(1). It is to be appreciated, however, that the elements of a given UD may vary from another UD and by implementation of the present disclosure. For example, different processors, data stores, user interfaces, and the like may be utilized by different UDs—such differences are beyond the scope of the present disclosure and each UD is to be considered herein as having those components needed to facilitate editing of a given digital content by a given user in accordance with an implementation of the present disclosure. Such components may be provided on/with a UD itself, on the Cloud, or otherwise.

As shown in FIG. 1 and for at least one implementation, a UD 102 may include a user device processor (UDP) 104, (such as the 1UD processor 104(1). The UDP 104 may be configured as one or more “processors” as defined above.

The UD 102 may further include a data store 112, such as the 1UD data store 112(1). The data store 112 may be configured as one or more “data stores,” as defined above.

The UD 102 may further include a user interface 120, such as the 1UD user interface 120(1). The user interface 120 may be configured as one or more “user interfaces,” as defined above.

The UD 102 may further include at least one input/output (I/O) device 122, such as the 1UD I/O devices 122(1). The I/O device(s) 122 may include one more “audible technologies,” “visible technologies” (as respectively defined above), or the like. The I/O device(s) 122 utilized for a given implementation, may be provided in conjunction with a given UD 102 and/or separately and coupled to the given UD 102.

The UD 102 may further include at least one communications interface 124, such as the 1UD communications interface 124(1)). The communications interface 124 may be configured as one or more “communications interfaces,” as defined above.

The UD 102 may further include a security module 128, such as the 1UD security module 128(1). The security module 128 may be configured as one or more security modules, as defined above.

The UD 102 may further include a power module 130, such as the 1UD power module 130(1). The power module 130 may be configured as one or more “power modules,” as defined above.

The UD 102 may further include one or more other modules, components, engines, applications, data stores, data files, computer instructions, or the like (herein “components”) that are commonly provided with and/or coupled to a given UD - such components may be currently known and/or later developed and/or provided. Such components, for a given implementation of the present disclosure may be agnostic to and/or specifically configured to facilitate one or more implementations of the present disclosure.

### User Device Processor (UDP) 104

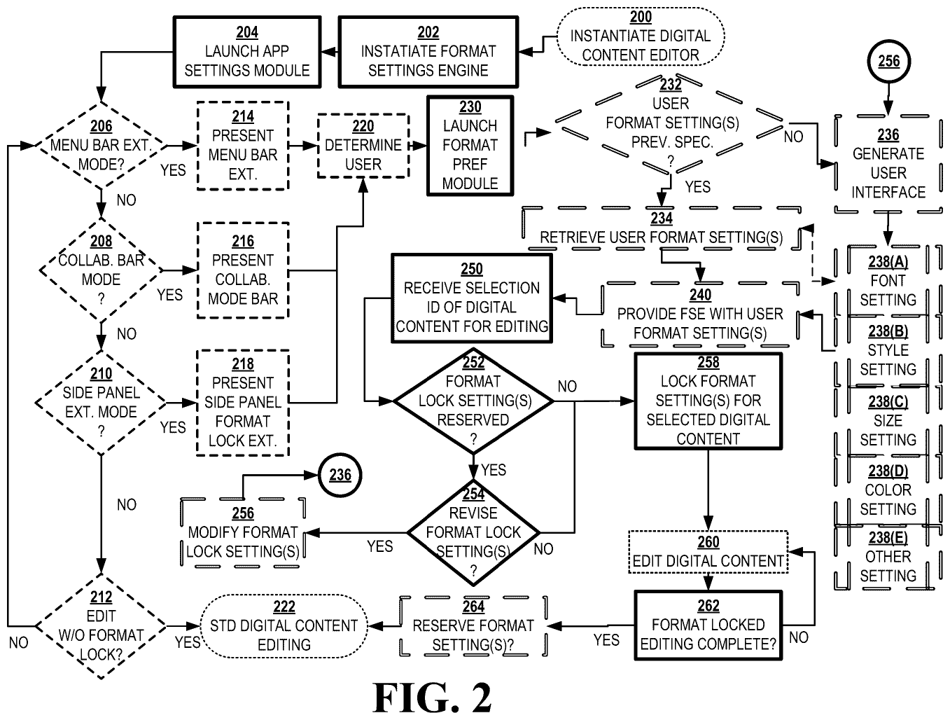

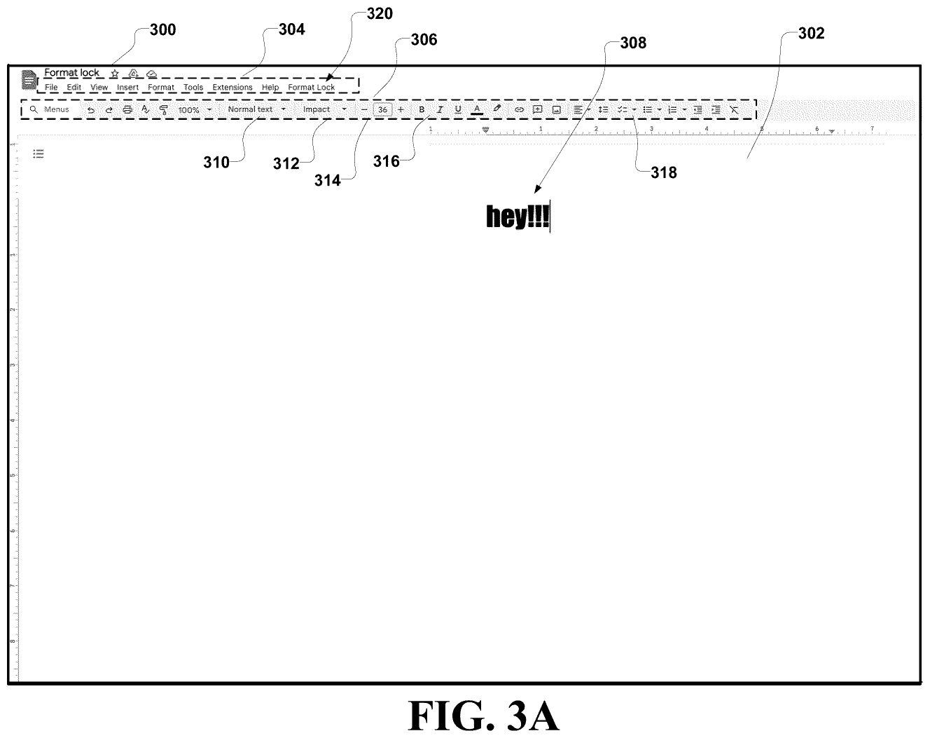

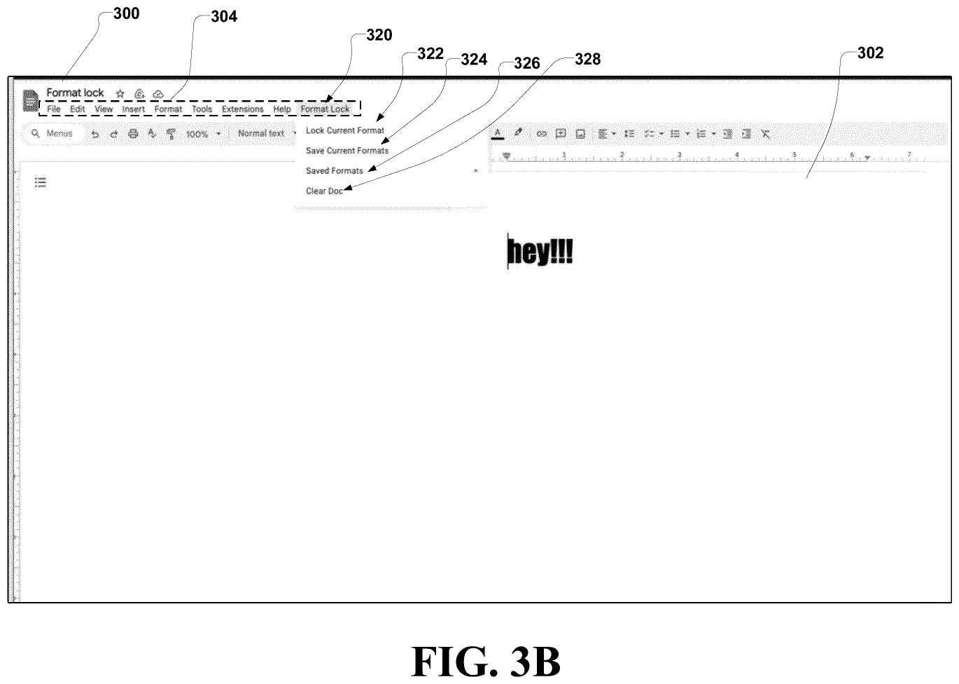

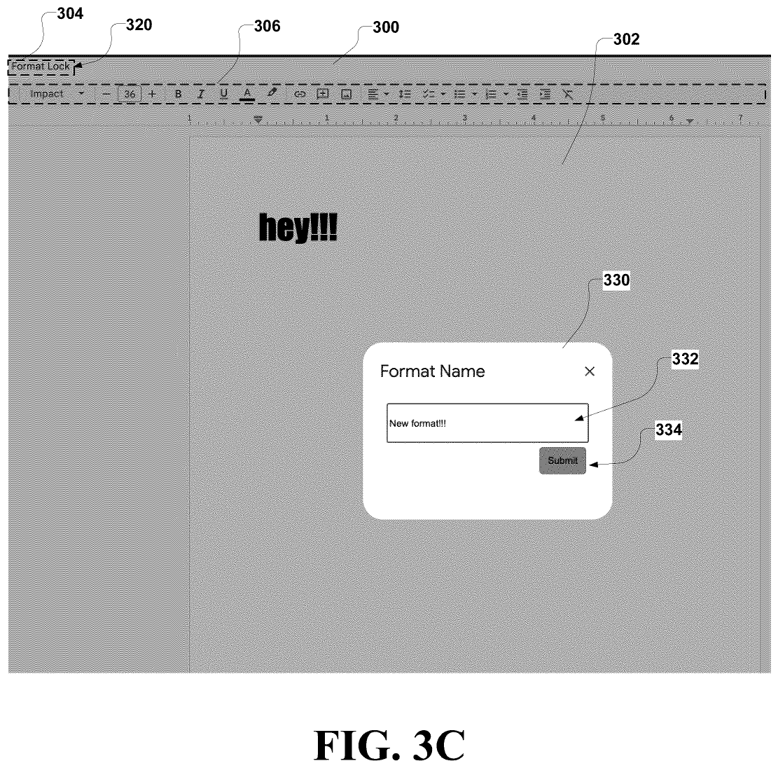

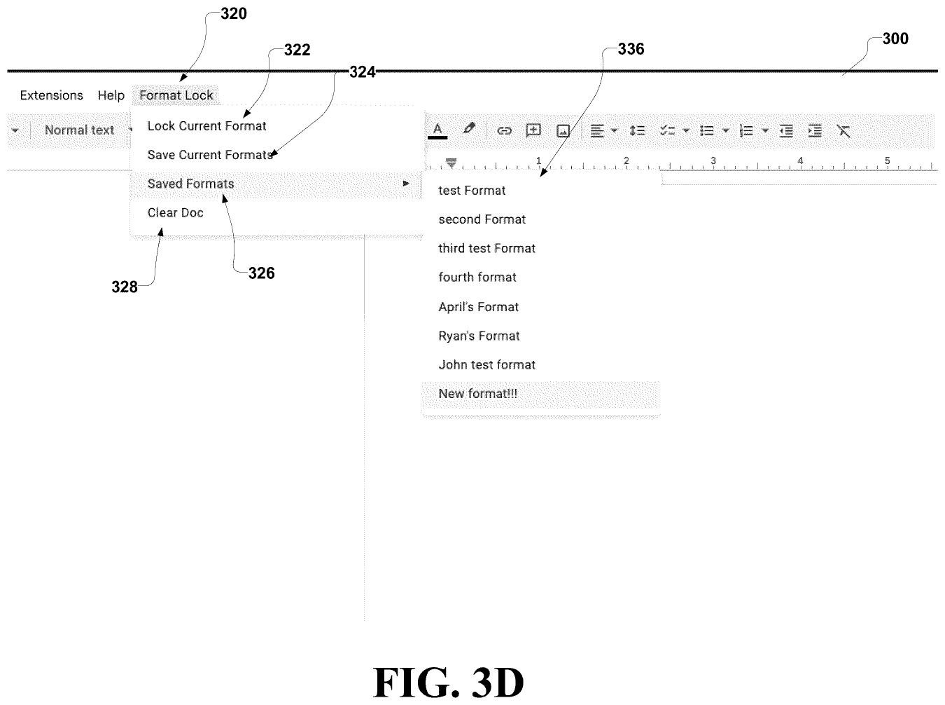

For at least one implementation, the UDP 104 may be configured to execute first computer instructions (1CI) which instantiate a file format settings engine 106 (FFSE). The FFSE configures a given UD 102 to perform one or more UD format locking operations (FLO). For at least one implementation, the FLOs are further described hereinbelow and with respect to FIGS. 2 and 3A-3D. For at least one implementation, the 1CI may be non-transitorily stored as content locking data (CLD) 114 in the UD data store 112 (such as the 1UD data store 112(1)). For at least one implementation, the 1CI may be non-transitorily stored on the Cloud 140, the server 150, and/or otherwise and retrieved therefrom for use, or instructed to be executed by another processor in a distributed, virtualized, cooperative or other processing environment.

As shown in FIG. 1 and in FIG. 2 and for at least one implementation, the UDP 104, may be further configured to execute second computer instructions (2CI) which instantiate an application settings module (ASM) 108, such as the 1UD ASM 108(1). The ASM 108 may configure the UD 102 to perform application setting operations (ASO). For at least one implementation, the 2CI may be non-transitorily stored as application locking data (ALD) 116 in the UD data store 112 (such as the 1UD data store 112(1)). For at least one implementation, the 2CI may be non-transitorily stored on the Cloud 140, the server 150, and/or otherwise and retrieved therefrom for use, or instructed to be executed by another processor in a distributed, virtualized, cooperative or other processing environment.

As shown in FIG. 1 and in FIG. 2 and for at least one implementation, the UDP 104, may be further configured to execute third computer instructions (3CI) which instantiate a format preferencing module (FPM) 110. The FPM 110 may configure the UD 102 to perform format preferencing operations (FPO). For at least one implementation, the 3CI may be non-transitorily stored as user lock preference data (ULPD) 118 in the UD data store 112 (such as the 1UD data store 112(1)). For at least one implementation, the 3CI may be non-transitorily stored on the Cloud 140, the server 150, and/or otherwise and retrieved therefrom for use, or instructed to be executed by another processor in a distributed, virtualized, cooperative or other processing environment.

As shown in FIG. 2 and for at least one implementation of the present disclosure, a UD 102 may be configured to perform one or more FLOs which facilitate format locking with respect to a given digital content and/or multiple instance of digital content. In FIG. 2, FLOs (such as Operations 202, 204, 230 and 250-254, 258 and 262) are indicated in bold lines, ASOs (such as Operations 206-220) are indicated by “half-dash” lines, FPOs (such as Operations 232-240, 256 and 264) are indicated by double-dashed lines, and standard operations (i.e., those not involving format locking operations, such as Operations 200, 222 and 260) are identified by dotted lines.

As per Operation 200 and for at least one implementation, a given UD 102, such as the first UD 102(1), may select for use by a user thereof, a digital content editor. A non-limiting example of a digital content editor is the DOCS™ application program provided by Google Inc. An example of a digital content editor 300 is shown in FIGS. 3A-3D. As shown, a non-limiting example of a digital content editor is the DOCS application, which is suitably presented on a display coupled to a given UD 102 for use in generating and editing documents containing text, graphics, and other information. As shown, the digital content editor may include an entry field 302 into which a user may input textual information and the like. For example, the user has entered the phrase “hey!!!” as shown by callout 308. The digital content editor 300 may also include a top menu bar 304. The top menu bar may include options for common document editing operations including “file,” “edit,” “view” and the like. The top menu bar 304 may also include one or more plug-ins (which are also referred to as an “extension” by Google). The digital content editor 300 may also include one or second menu bars, such as the second menu bar 306 shown in FIGS. 3A-3D. For at least one implementation, the second menu bar 306 may include a style option field 310 for selecting a text style, with a “Normal” text style being shown. The second menu bar 306 may also include one or more font option fields. Such font option fields may include, without limitation, a first/type font option field 312, a second/size font option field 314, a third/font treatment option field 316, and other font option fields (not shown and as may arise with respect to a given digital content editor). The second menu bar 306 may include other fields, including a paragraph option field 318. As used herein, one or more of the style option field, first through third font option fields and the paragraph option field may be selectable by a user and used to specify a given “format style” that is uniquely associated with a given user with respect to one or more instances of digital content that is editable using one or more forms of a digital content editor.

As per Operation 202 and for at least one implementation, the selection for use of the digital content editor may be followed by an instantiating of the file format settings engine (FFSE) 106. For at least one implementation, the FFSE 106 may be instantiated whenever a given digital content editor is instantiated. For another implementation, the FFSE 106 may be instantiated upon user input. For a non-limiting example, the FFSE 106 may be configured as a plug-in that is instantiated whenever an underlying digital content editor (e.g., DOCS) is instantiated. For at least one implementation, an FFSE 106 is instantiated when the user affirmatively selects use of the FFSE 106. Upon instantiating of the FFSE 106, one or more FLO may occur. As shown in FIGS. 3A-3D, when the FFSE 106 is instantiated, a “format lock” extension 320, or the like, may be presented on the top menu bar 340.

As per Operation 204 and for at least one implementation, the FLO may include the FFSE 106 launching the application settings module (ASM) 108. The ASM 108 is further described below with reference to Operations 206-222. The ASM 108 implements application setting operations (ASO) which generates user interfaces options by which a given user may select one or more format settings to be locked, retrieve previously saved format lock settings, and the like. A non-limiting example of such a user interface is the addition of the “format lock” plug-in 320 to the top menu bar 304 for the DOCS digital content editor, as shown in FIGS. 3A-3D.

As per Operations 206-212 and for at least one implementation, the ASO may include the ASM 108 querying the user as to which of one or more format locking modes the user wants to use. Non-limiting examples of format locking modes that a given digital content editor may be configured to support, as embedded application code and/or as a plug-in, include a menu bar extension mode (as per Operation 204 and as shown in FIGS. 3A-3D), a collaborate bar mode (as per Operation 208), and a side panel mode (as per Operation 210). It is to be appreciated that a digital content editor may support one or more, including each, of the format locking modes identified by Operations 206-210.

As shown by Operation 212, a given digital content editor may not support format locking. When such a condition arises, the ASM 108 may proceed to Operation 222. For at least one implementation, Operation 222 may be implemented by the digital content editor without involvement of the ASM 108 or FFSE 106. For at least one implementation, one or more format lock modes (as per Operations 206-212) or non-format lock mode (as per Operation 222) may be selected by a user at any time during editing of a given digital content. It is to be appreciated that a user may select (and correspondingly instruct the FFSE 106) to implement and/or de-implement format locked editing at any time including during editing and/or post editing of the given digital content. For example, a user may determine at a later time to not use format locking to specifically identify edits to the given digital content as having been provided by that user.

Depending upon which of the available format locking modes, if any, that a given digital content editor supports, and as indicated by a user selection received by the ASO, the process may proceed to one or Operations 214-220.

As per Operations 214-220 and for at least one implementation, the ASO may include generating and communicating to the user interface 120 data for generating, on a given I/O device 122 coupled to the UD 102, a user interface for one or more of the menu bar extension mode, the collaborate mode, or the side panel mode. A non-limiting of a menu bar extension mode is shown in FIGS. 3A-3D. For at least one implementation, the given format lock mode presented may be configured by a default digital content editor setting, a device setting, or otherwise.

As per Operation 214 and as further shown in FIG. 3 for at least one implementation, when the menu bar extension mode is selected by user (as per Operation 206), the ASO may include the ASM 108 generating data for use in presenting the format lock plug-in 320. The format lock plugin 320 may be presented in conjunction with and/or on the top menu bar 304 or otherwise. For at least one implementation, the format lock plugin 320 may include one or more of the user format lock control options, as shown in FIG. 3B, including a lock option 322 (which is shown in FIG. 3B as the “Lock Current Format” option), a save option 324 (which is shown in FIG. 3B as the “Save Current Formats” option), a recall option 326 (which is shown in FIG. 3B as the “Saved Formats” option), and a clear option 328 (which is shown in FIG. 3B as the “Clear Doc” option). Other user format lock control options may be provided for other implementations of the present disclosure.

For at least one implementation, the lock option 322 may be used to apply a format lock to currently selected font option field settings for a given digital content file that is currently opened and being edited using a given digital content editor. The font option field settings presently being utilized when the lock option 322 is selected are herein considered to be non-transitorily stored for use while the given digital content file is being edited the digital content editor instantiated for editing such digital content file is active. Such format lock settings, however, may be erased and/or deleted when the digital content file is closed and/or the digital content editor is deactivated.

For at least one implementation, the save option 324 may be used to save one or more of the font option field settings utilized during editing of a current digital content file by a given digital content editor.

For at least one implementation, the recall saved locks option 326 may be used to apply one or more previously saved format lock options to another instantiation of a given digital content file and/or to another digital content file. For at least one implementation, one or more of the format lock options may be universal and capable of use in two or more digital content editors such as a document edited (like DOCS) and an email program (like OUTLOOK).

For at least one implementation, the clear option 328 may be used to clear one or more current format option settings and return the format option settings to a default or otherwise previously specified format option setting.

As per Operation 216 and as further shown in FIG. 4 and for at least one implementation, when the collaborate mode is selected by user (as per Operation 208) the ASO may include the ASM 108 generating data for use in presenting a collaborate bar to the user. The collaborate may bar include options substantially similar to those provided by the format lock plugin 320.

As per Operation 218 and as further shown in FIG. 5 for at least one implementation, when the side bar extension mode is selected by user (as per Operation 210), the ASO may include the ASM 108 generating data for use in presenting the side panel format lock extension to the user. The side panel format lock extension may bar include options substantially similar to those provided by the format lock plugin 320.

As per Operation 220 and for at least one implementation, the ASO may include the ASM determining a given user of the digital content editor (as instantiated per Operation 200). For at least one implementation, the ASO may determine the given user based on communications with the security module, such as a communication of a user sign-on or other identifier provided to the UD 102 and verified by the security module 128. For another implementation, the given user may be determined based on credentials, passwords, pass codes, or the like provided by the given user during instantiation of the digital content editor (as per Operation 200), selection of the digital content for editing (as per Operation 250), or otherwise. When identifying the user, the ASO may include determining which, if any, of the format lock modes and/or format lock options the given user is permitted to utilize.

Accordingly, it is to be appreciated that Operation 220 may be initiated and occur before, during and/or after one or more of Operations 206-218. It is to be appreciated that the ASM 108 may be active and/or inactive during any time that the FFSE 106 is active. For at least one implementation, the ASM 108 may run on one or more threads supported by a given UDP 104 with other threads supporting the FFSE 106, FPM 110, digital content editor, and other applications and computer instructions then being performed by the UDP 104 at a given time.

As per Operation 230 and for at least one implementation, the FLO may include launching the format preferencing module (FPM) 110. It is to be appreciated that for at least one implementation, the FPM 110 may be an optional module that the FFSE 106 may or may not execute. When executed, the FPM 110 provides the given user with an option to specify the format settings to use while editing of the given digital content occurs. Such format settings may be those previously stored and/or one or more settings selected for use during a then occurring editing of the given digital content.

When the FPM 110 is not executed by the FFSE 106, the FFSE 106 may be configured to automatically specify one or more format lock settings by which edits, to the given digital content, by the given user will be identified. For a non-limiting example, a first user editing a given digital content (the first user may be an originator of the given digital content) may be designated without any format styling and using a preselected font, such as Times New Roman, Courier, or the like, and a given color, such as black. A second user may be preselected to have their edits identified in a second color, such a red, and with a bold styling. A third user may be preselected to use other (one or more) unique content formatting settings, and so on for other users. For at least one implementation, the format lock settings specified may be obtained from content locking data 114 and/or from app locking data 116, stored in the data store 112.

As per Operation 232 and for at least one implementation, the format preferencing operations (FPO) may include the FPM 110 determining whether the given user has previously specified one or more user format settings. When available, the FPO may proceed to Operation 234 otherwise the FPO proceeds to Operation 236.

As per Operation 234 and for at least one implementation, the FPO may include the FPM 110 retrieving one or more previously determined user format settings. For at least one implementation, such user format preference settings, if any, may be obtained from user lock preference data 118 stored by the data store 112.

As shown in FIGS. 3B and 3D, the FFSE 106 may be configured to present the recall saved locks option 326, which upon selection thereof by a user, may present one or more saved format locks 336, such as those shown in FIG. 3D. The saved format locks 336 may be presented by any user recognizable text, characters or the like, such as “test Format” and “second Format” (as shown in FIG. 3D). As shown in FIG. 3D, an identifier associated with a given save format lock may be generated in any manner including automatically, numerically, alphabetically or otherwise. For at least one implementation, a numerical sequence may be used to identify saved format locks, such as the format lock names “first Format” and “second Format” shown. For at least one implementation, a format lock name may be generated based, in whole or in part, on a user identifier-as represented in FIG. 3D by the format lock names “April's Format” and “Ryan's Format.” For at least one implementation, a format lock name may be uniquely generated, e.g., based upon a user's input, such as the “John test format” shown in FIG. 3D. When a format lock name is to be uniquely generated, for at least one implementation and as shown in FIG. 3C, the FFSE 106 may be configured to generate, for presentation on a display coupled to a UD 102, a format lock naming window 330. The format lock naming window 330 may include a format lock naming field 332, in which a user may input alphanumeric characters to name a given format lock, and a format lock submit button 334. Upon selection of the format lock submit button 334, one or more of the selections in the, as then appearing, first font option field 312, second font option field 314, and third font option field 316 may be saved. The FPO may then proceed to Operation 240.

As per Operation 236 and for at least one implementation, the FPO may include the FPM 110 generating a user interface configured to present at least one format style setting option to a given user and capture the given user's selection thereof. Wherein the format style setting option(s) selected may be used to uniquely identify, to one or more other users subsequently and/or temporarily viewing the digital content, the given user's edits to the given digital content. For at least one implementation, the user interface may be provided in view of the format mode provided by the ASO, as per Operations 206-210.

As per Operation 238 and for at least one implementation, the FPO may include the user, via the user interface provided per Operation 234 or otherwise, specifying at least one of, per Operation 238(A) , a font setting option (with non-limiting examples including fonts such as Times New Roman, Arial, Courier and the like), with a non-limiting example being shown in FIG. 3A by the first/type font option field 312. Further, per Operation 238(B) , a style setting option (with non-limiting examples including bold, italics, underline, and the like) may be specified, with a non-limiting example being shown in FIG. 3A by the third/treatment font option field 318. Further, per Operation 238(C) , a size setting option (with non-limiting examples including 10 pt., 12 pt., or the like) may be specified, with a non-limiting example being shown in FIG. 3A by the second/size font option field 316. Further, per Operation 238(D) , a color setting option and/or per Operation 238(E) , other format setting options (such as highlighted, shadow text, and the like), may be specified, with a non-limiting example being shown in FIG. 3A by the third/treatment font option field 316. It is to be appreciated that any form of user interface may be used to specify one or more of the format setting options per Operations 236(A)-236(E).

As per Operation 240 and for at least one implementation, the FPO may include the FPM providing the one or more user format settings retrieved, per Operation 234, or generated per Operations 236-238, to the FFSE 106. As discussed above, the FPO may also include storing the one or more format settings generated per Operations 236-238 as lock preference data 116—as stored by the data store 112. The process then returns to the FFSE 106.

As per Operation 250 and for at least one implementation, the FLO may include the FFSE 106 receiving an identification (ID) of the digital content that has been selected for digital content editing and with a format lock mode being enabled for such digital content editing. For at least one implementation, the ID of the digital content may occur using any file opening, retrieval or similar operations provided by a given digital content editor.

As per Operation 252 and for at least one implementation, the FLO may include determining if one or more format lock settings have been previously reserved for the selected digital content. It is to be appreciated that a digital content may be limited as to formatting available to be used therewith, for example, italicized text might not be permitted for a first form of digital content, while being permitted or another form of digital content. Similarly, the selected digital content may include one or more restrictions for format locks. Such restrictions me be applied based on an identification of the creator of the selected digital content, the current user seeking to edits the selected digital content, or otherwise. When a format lock setting reservation exists, the FLO may proceed to Operations 254. When a format lock setting reservation does not exist, the FLO may proceed to Operation 258.

As per Operation 254 and for at least one implementation, the FLO may include determining whether the current user seeking to use a format lock with respect to the selected digital content desires to use a different format lock setting. IF “YES,” the FLO proceeds to Operations 256. If “NO,”the FLO proceeds to Operation 258.

As per Operation 256 and for at least one implementation, the FLO may include modification of one or more format lock settings, as may be specified by Operations 236-252. For at least one implementation, Operations 256 and 236-254 may be repeated until one or more format lock settings is identified that do not conflict with any reserved format lock settings (as determined per Operation 252) are specified.

As per Operation 258 and for at least one implementation, the FLO may include the FFSE 106 instructing the digital content editor instantiated per Operation 200, to lock format editing by the user determined per Operation 220, for the digital content as selected per Operation 250.

As per Operation 260 and for at least one implementation, editing of the digital content, with the format locks set per Operation 258, proceeds. The actual editing of the digital content, as distinguished from the formatting used to identify editing, is beyond the scope of the present disclosure.

As per Operation 262 and for at least one implementation, the FLO may include the FFSE 106 determining if the format locked editing of the selected digital content is complete. For at least one implementation, Operation 262 may be repeated on a pre-determined periodic basis, such as once every thirty minutes. For another implementation, Operation 262 may be performed when the data file (or the like) containing the selected digital content is closed.

As per Operation 264 and for at least one implementation, the process may again involve the FPM and the FPO may include determining whether one or more of the format settings locked per Operation 258 are to be reserved for future use by given user. The process may then proceed to Operation 222 and resuming standard (non-format locked) editing of the selected digital content and/or of other instances of digital content.

It is to be appreciated that the Operations depicted in FIG. 2 may occur in the sequence as shown, and/or in any other sequence of operations including one more operations occurring in parallel.

### Format Lock Server (Server) 150

As further shown in FIG. 1, the FLS 100 may include at least one server 150. For at least one implementation, the server 150 may be provided by one or more AWS, GOOGLE, MICROSOFT or other Cloud based systems. Such Cloud based systems may be distributed, centralized, localized or otherwise provided.

The server 150 may be configured to include at least one server processer (SP) 152 configured to execute server 1^{st} computer instructions (1SCI) that, when executed by the SP 152, instantiate a server file format settings engine (S-FFSE) 154 that configures the server 150, and/or instructs one or more UDs 102, such as the 1UD 102(1) and the NUD 102(N), to perform one or more server format locking operations (S-FLO). For at least one implementation, the S-FLO and FLO (as described above with respect to the implementation of FIG. 2) may be substantially same, with a PHOSITA appreciating that differences therein may arise due to uses of different operating systems, application programs, file types, and the like.

As shown in FIG. 1 and for at least one implementation, the S-FFSE 154 may be configured to implement second server computer instructions (2SCI) for a server application settings module 156 that configures the server 150, and/or instructs one or more UDs 102, to perform one or more server application setting operations (S-ASO). For at least one implementation, the S-ASO and ASO (as described above with respect to the implementation of FIG. 2) may be substantially same, with a PHOSITA appreciating that differences therein may arise due to uses of different operating systems, application programs, file types, and the like.

As shown in FIG. 1 and for at least one implementation, the S-FFSE 154 may be configured to implement third server computer instructions (3SCI) for a server application settings module 156 that configures the server 150, and/or instructs one or more UDs 102, to perform one or more server format preferencing operations (S-FPO). For at least one implementation, the S-FPO and FPO (as described above with respect to the implementation of FIG. 2) may be substantially same, with a PHOSITA appreciating that differences therein may arise due to uses of different operating systems, application programs, file types, and the like.

For at least one implementation, the 1SCI, 2SCI and 3SCI may be obtained from a server data store 160 that non-transitorily stores such computer instructions for use by the server 150 and/or the one or more UDs 102. When executed by the UDs 102, such computer instructions are non-transitorily stored, correspondingly, by the user device data stores 112 and/or user device processors (UDPs) 104.

As further shown in FIG. 1 and for at least one implementation, the server 150 may be configured to non-transitorily store content lock data 162, application lock data 164, and user lock preferences data 166. For at least one implementation, such data is substantially the same as the data stored in the UD 102, as discussed above. As used herein such data is substantially the same, when the information that can be conveyed by the data, when such data is converted into information, is substantially similar such that a PHOSITA would understand the importance, meaning, context, and the like of the information being conveyed.

As further shown in FIG. 1 and for at least one implementation, the server 150 may further include at least one user interface 168 coupled to one or more input/output (I/O) devices (not shown). The I/O device(s) may include one more “audible technologies,” “visible technologies” (as respectively defined above), or the like. The I/O device(s) utilized for a given implementation, may be provided in conjunction with a given server 150 and/or separately and coupled to the given server 150.

The server 150 may further include at least one communications interface 170. The communications interface 170 may be configured as one or more communications interfaces, as defined above.

The server 150 may further include a security module 172. The security module 172 may be configured as one or more security modules, as defined above.

The server 150 may further include a power module 174. The power module 174 may be configured as one or more power modules, as defined above.

The server 150 may further include one or more other modules, components, engines, applications, data stores, data files, computer instructions, or the like (herein “components”) that are commonly provided with and/or coupled to a given server—such components may be currently known and/or later developed and/or provided. Such components, for a given implementation of the present disclosure may be agnostic to and/or specifically configured to facilitate one or more implementations of the present disclosure.

For at least one implementation of the present disclosure, the FFSE 106 may be configured to perform additional operations that facilitate format locked editing of a given digital content. Such editing operations may occur in conjunction with one or more of the FLO, ASO and FPO described above. For at least one implementation such additional operations may include removing from the given digital content one or more instance of trailing paragraphs at the end of the given document or elsewhere. As used herein, a trailing paragraph is a paragraph or other break in a given digital content that is greater than a predetermined length, such as one line in a WORD document or multiple pages in an EXCEL document, and wherein data is not provide in such break that, when rendered in a humanly perceptible form, conveys information to a given user presented with the digital content.

For at least one implementation, the additional operations may include determining a format setting for a given portion of the given digital content. It is to be appreciated that a given digital content may include multiple delineable portion of data that may have varying formatting settings applied thereto. For example, a first paragraph of a WORD document may have no styling applied, while a second paragraph therein has a bold style setting applied. The user of the bold style setting may be considered reserved by the originator of the given digital content and the operations of FIG. 2 may be modified accordingly to inhibit use of bold styling by another user (and/or the originator) during editing of that section (the paragraph containing the bold styling) of the digital content.

For at least one implementation, the additional operations may include providing an option for providing a format lock name that uniquely identifies the one or more format lock settings specified per Operation 258. For at least one implementation, the format lock name may be automatically generated based on the user ID, as determined per Operation 220 and/or the digital content ID, as determined per Operation 250. For at least one implementation, the format lock name may be saved in the data store 112 and/or server data store 160 and retrieved for a later editing of the same or different digital content.

For at least one implementation, the additional operations may include the FFSE 106 providing a cursor lock functionality that includes determining a current cursor position (or a current position of an indicator within the digital content) and designating that the format lock applies to edits made by the given user, as determined per Operation 220, in the digital content (as determined per Operation 250) and at the current cursor position. For at least one implementation, the cursor lock position may be applied to a current cursor position with respect to which a format lock was first retrieved (as per Operation 234) or selected (as per Operation 236-238) and an edit to the given digital content provided by the given user and with respect to one or more subsequent cursor positions at which another edit to the given digital content was provided by the given user. For at least one implementation, a user input operation, such as a hotkey operation, a voice prompt (e.g., the user stating, “Lock Format” and “Unlock format”) may be configured to trigger the use (or non-use) of the format lock at a current cursor position.

It is to be appreciated that other operations may be provided which facilitate the user of format locks on given instances of digital content. The types of digital content with respect to which a format lock may be used are infinitely variable and accordingly, the type of format lock applied may vary. For example, a format lock used for editing colors, shades, hues, contrast, and the like in bitmapped image, such as a photograph, may vary by pixel size, surrounding pixels implicated, and the like, whereas a format lock used for editing text in that image document, such as a title, location descriptor, or the like may be applied on a less granular basis, such as a character (as distinguished from pixel) basis, which a PHOSITA would appreciate might involve multiple pixels all being commonly used to form the given alphanumeric or the like character.

Although various implementations have been described above with a degree of particularity, or with reference to one or more individual implementations, those skilled in the art could make alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

What is claimed is:

1. A user device comprising:
a user device data store (UDDS);
wherein the UDDS non-transitorily stores first computer instructions which,
when executed, instantiate a format settings engine (FSE); and
a user device processor (UDP) coupled to the UDDS; and
wherein the UDP, when executing the first computer instructions, instantiates the FSE which configures the user device to perform format locking operations (FLO) comprising:
locking at least one format style setting option for editing of a given digital content by a first user of the user device.

2. The user device claim 1, further comprising:
a user interface coupled to the UDP;
wherein the user interface presents multiple format style setting options to the first user; and
wherein the locking of the at least one format style setting option comprises:
receiving a first selection, by the first user, of at least one of the multiple format style setting options; and
wherein upon the first selection of the at least one of the multiple format style setting options, edits made by the first user to the given digital content are distinguishable from other edits made to the given digital content by a second user or another user.

3. The user device of claim 2, further comprising:
a communications interface coupling the user device with a second user device utilized by the second user; and
wherein the FLO further comprise:
communicating, substantially contemporaneously with an entry of the edits by the first user and in accordance with the at least one of the multiple format style setting options selected by the first user, the edits to the given digital content to the second user device.

4. The user device of claim 3,
wherein the multiple format style setting options include at least one of a font setting option, a style setting option, a size setting option, and a color setting option.

5. The user device of claim 4,
wherein the multiple format style setting options are provided by an application program facilitates editing of the given digital content.

6. The user device of claim 5,
wherein the application program is at least one of a document editor, a spreadsheet editor, a photo editor, and a video editor.

7. The user device of claim 5,
wherein the FLO further comprise:
determining whether at least one of the multiple format style setting options selected by the first user in the first selection are reserved for use by another user; and
informing the first user when at least one of the multiple format style setting options selected in the first selection are reserved; and
receiving a second selection of another of at least one of multiple format style setting options that are not reserved for use by another user.

8. The user device of claim 7,
wherein the UDDS non-transitorily stores second computer instructions which, when executed by the UDP, instantiate an application settings module (ASM);
wherein the UDP, when executing the second computer instructions, instantiates the ASM which configures the user device to perform application settings operations (ASO) comprising:
presenting a format locking mode on the user device.

9. The user device of claim 8,
wherein the format locking mode include a menu bar extension mode; and
wherein the menu bar extension mode include a format lock plug-in which facilitates the locking of the first selection of the at least one format style setting option during editing of the given digital content by the first user of the user device.

10. The user device of claim 9,
wherein the format lock plug-in, when selected by the first user, presents format lock control options including at least one of a lock option, a save option, a recall option, and a clear option.

11. The user device of claim 10,
wherein the lock option, when selected by the first user, locks the first selection of the at least one of the multiple format style setting option.

12. The user device of claim 11,
wherein the UDDS non-transitorily stores third computer instructions which, when executed by the UDP, instantiate a format preferences module (FPM);
wherein the UDP, when executing the third computer instructions, instantiates the FPM which configures the user device to perform format preferencing operations (FPO) comprising:
determining whether the first user has previously stored the first selection in the UDDS; and
when previously stored,
retrieving the first selection from the UDDS; and
providing the first selection to the FSE; and
wherein the first selection of the at least one format style setting is utilized by the application program during editing of the digital content by the first user.

13. A system, facilitating locking of format settings for two or more users editing a given digital content, comprising:
a first user device (1UD) comprising:
a first user device data store (1UDDS);
wherein the 1UDDS non-transitorily stores first user device first computer instructions (1UD1CI) which, when executed, instantiate a first format settings engine (1FSE); and
a first user device processor (1UDP) coupled to the 1UDDS;
wherein the 1UDP, when executing the 1UD1CI, instantiates the 1FSE which configures the 1UD to perform first format locking operations (1FLO) comprising:
first locking a first format style setting option for editing of a given digital content by a first user of the 1UD;
at least one second user device (2UD), coupled to the 1UD, comprising:
a second user device data store (2UDDS);
wherein the 2UDDS non-transitorily stores second user device first computer instructions (2UD1CI) which, when executed, instantiate a second format settings engine (2FSE); and
a second user device processor (2UDP) coupled to the 2UDDS;
wherein the 2UDP, when executing the 2UD1CI, instantiates the 2FSE which configures the 2UD to perform second format locking operations (2FLO [symbol] comprising:
second locking a second format style setting option for editing of the given digital content by a second user of the 2UD; and
a format lock server, coupled to the 1UD and the 2UD, comprising:
a server data store (SDS);
wherein the SDS non-transitorily stores server first computer instructions (S1CI) which, when executed, instantiate a server format settings engine (SFSE); and
a server processor (SP) coupled to the SDS;
wherein the SP, when executing the S1CI, instantiates the SFSE which configures the server to perform server format locking operations (SFLO) comprising:
receiving, from the 1UD, the first format style setting option locked by the 1FSE; and
receiving, from the 2UD, the second format style setting option locked by the 2FSE.

14. The system of claim 13,
wherein the first format style setting option locked by the 1FSE is different than the second format style setting option locked by the 2FSE.

15. The system of claim 14,
wherein the SFLO further comprise:
communicating, to the 2UD and a third user device, edits by the first user to the given digital content in accordance with the first format style setting option; and
communicating, to the 1UD and the third user device, edits by the second user to the given digital content in accordance with the second format style setting option.

16. The system of claim 15,
wherein the 1UDDS non-transitorily stores 1UD second computer instructions (1UD2CI) which, when executed, instantiate a first application settings module (1ASM);
wherein the 1UDP, when executing the 1UD2CI, instantiates the 1ASM which configures the 1UD to perform first application settings operations (1ASO) comprising:
first presenting a first format locking mode on the 1UD;
wherein the 2UDDS non-transitorily stores 2UD second computer instructions (2UD2CI) which, when executed, instantiate a second application settings module (2ASM);
wherein the 2UDP, when executing the 2UD2CI, instantiates the 2ASM which configures the 2UD to perform second application settings operations (2ASO) comprising:
second presenting a second format locking mode on the 2UD.

17. The system of claim 16,
wherein the first format locking mode and the second format locking mode comprise at least one of a menu bar extension mode, a collaboration bar mode, and a side panel extension mode.

18. The system of claim 16,
wherein the menu bar extension mode includes a format lock plug-in that facilitates the locking of selections of at least one of the first format style setting option and the second format style setting option during a respective editing of the given digital content by the first user or the second user.

19. The system of claim 18,
wherein the 1UDDS non-transitorily stores 1UD third computer instructions (1UD3CI) which, when executed, instantiate a first format preferences module (1FPM);
wherein the 1UDP, when executing the 1UD3CI, instantiates the 1FPM which configures the 1UD to perform first format preferencing operations (1FPO) comprising:
first determining whether the first user has previously stored the first selection in the 1UDDS; and
when previously stored,
retrieving the first selection from the 1UDDS; and
providing the first selection to the 1FSE; and
wherein the first selection of the at least one format style setting is utilized by an application program during editing of the digital content by the first user.

20. A computer readable medium non-transitorily storing computer instructions which, when executed by a processor, instantiate a format settings engine which configures a user device to perform format locking operations comprising:
locking at least one format style setting option for editing of a given digital content by a first user of the user device.
